(19) United States
(12) Patent Application Publication
(10) Pub. No.: US 2004/0084087 A1
(43) Pub. Date: May 6, 2004

(54) Apparatus and method for controlling and distributing gas flow

(76) Inventors: John E. Sanfilippo, Barrington Hills, IL (US); James J. Sanfilippo, Barrington Hills, IL (US)

Correspondence Address: Dykema Gossett, PLLC, Suite 300 West, 1300 I Street, N.W., Washington, DC, 20005-3306, US

(21) Appl. No.: 10/689,780

(22) Filed: Oct. 22, 2003

Related U.S. Application Data
(60) Provisional application No. 60/422,152, filed on Oct. 30, 2002.

(51) Int. Cl. G05D 7/06

(52) U.S. Cl. 137/487.5

(57) ABSTRACT

The present invention provides a gassing lance including a base and an extension. The base includes a docking port connectable to an input member for transmitting gas to the gassing lance, and the extension includes laminar and accelerator gassing elements for transmitting gas through the gassing lance at first and second flow rates. The gassing lance is affixable within a conventional forming tube of a packaging machine. The invention also provides a gas control panel for controlling and directing gas flow. The gas control panel includes first and second circuits for controlling laminar and accelerator gas flow, respectively, through the gassing lance. The gas control panel also includes a Programmagle Logic Control for controlling the first and second circuits based upon a desired gas characteristic input at an operator interface, and measured by a gas analyzer, thereby providing real-time-control of gas characteristics of gas exiting through the gassing lance.

### RELATED APPLICATIONS

This application claims benefit of priority of Provisional Application Serial No. 60/422,152, filed Oct. 30, 2002.

### BACKGROUND OF INVENTION

a. Field of Invention

The invention relates generally to the control and distribution of gas flow, and, more particularly to an apparatus for directing and distributing gas, and an apparatus and method for continuous monitoring and control of gas properties during distribution thereof to a predetermined location, such as a food product container.

b. Description of Related Art

Conventional gassing operations include the exchange and/or insertion of a gas from a food product container or other environmentally sensitive products. In the past, gassing systems have utilized gas control panels in conjunction with gassing lances to exchange and/or insert an environment gas as needed. As industry usage of conventional gas control panels and gassing lances has become increasingly diversified, there exists a present need for a compact, versatile and robust gassing system.

As discussed above, gassing systems generally include a gas control panel in conjunction with a gassing lance for removal and/or insertion of an environment gas. A gassing lance is generally an extended tube, having inlet and exit openings, through which environment gas may be supplied into a package before sealing. The gassing lance may be installed in a generally vertically oriented forming tube of a packaging machine to direct gas into a package through its exit opening adjacent the bottom of the forming tube. After insertion of a specified amount of gas into the package, the package may be sealed. The inlet end of the gassing lance may be connected to a gas supply, which may be controlled by a gas control panel.

In the industry, several problems however presently exist with the design and operational characteristics of conventional gassing lances and gas control panels.

One such problem with conventional gassing lances is that the single exit opening or multiple exit openings adjacent the bottom of the tube can cause excessive turbulence as the gas exits, and thus cause the contents of the package to be unevenly distributed or the package seal area to become contaminated with product. For a gassing lance mounted on a horizontal flow wrapper as opposed to a generally vertical forming tube, it is apparent that in an horizontal orientation the above-identified problems are magnified. Accordingly, there exists a need for a gassing lance which is compact, versatile and robust, and which can provide sufficient gas flow to quickly transmit or exchange gas from a package without unnecessarily disturbing or contaminating the package contents.

In the case of gas control panels, as disclosed in U.S. Pat. No. 5,918,616 to Sanfilippo et al. (the disclosure of which is incorporated herein by reference), there has been designed, manufactured and utilized herewith a first embodiment of a gas control panel in which a manifold may be used to supply gas to a gassing lance via solenoid valves. In the first embodiment of the gas control panel, the gas feed from each solenoid valve may be directed and controlled by a manually operated valve/flowmeter. Each valve/flowmeter may connect to a second manifold with a spool inserted therein for grouping with other valves/flowmeters. Each flowmeter may also include an outlet port. This gas control panel design has drawbacks in that it may be difficult for an operator to determine the grouping arrangement of the valves/flowmeters. Additionally, if the grouping arrangement of a set of valves/flowmeters is changed, it may become necessary to redesign the spool for the new valve/flowmeter arrangement.

In yet a further development, there has been designed, manufactured and utilized herewith a second embodiment of a gas control panel in which electronic flowmeters may be used in conjunction with manually adjusted valves. The design of the second embodiment improves upon the first embodiment by replacing the manually operated valves/flowmeters. The design of the second embodiment is superior, in that the electronic flowmeters may be used to compensate for various parameters, such as gas temperature and gas pressure, which provides increased accuracy in the gas flow rate. The electronic flowmeters may also include an integral switch, which may be tied into a Programmable Logic Control (PLC), to alert an operator of flow problems, or to instruct an operator to perform a specified function.

One drawback with the above-identified first and second embodiments is that the gas control panel may only be used to control a single specific gas flow through a gassing lance, and not for control of multiple gas flows through the gassing lance. Accordingly, there exists a need for a gas control panel which is compact, versatile and robust, and which can control multiple gas flows through a gassing lance.

Another drawback of the above-identified first and second embodiments is that in order for an operator to be certain of the gas environment in a package, it is necessary for a test package to be destroyed after sealing to determine if the gas environment conforms to the required specifications for the package. If the gas environment in the package is out of conformity with the required specifications, it is necessary to manually adjust the valves and to re-test a new package until the required specifications are met. It is apparent that in a high-speed manufacturing environment, such a trial-and-error procedure, which requires system shut-down and manual adjustment of valves, can be extremely time consuming and detrimental to a production operation. Additionally, due to the requirement for manual adjustment of the valves, operator error can be a factor in the resulting precision and operational characteristics of the gas control panel.

Various conventional gassing systems and associated inventions, which overcome some of the drawbacks and disadvantages of prior art gas control panels, are known and disclosed, for example, in U.S. Pat. No. 5,632,306 to Taka and U.S. Pat. No. 4,174,733 to Eidsmore et al.

For the U.S. Patents cited above, from an operational standpoint, the industrial operation of the relatively inflexible and/or unautomated gassing systems of the past has resulted in a noticeable increase in the overall operational cost thereof, due to the drawbacks and disadvantages discussed above. From an assembly standpoint, the assembly and installation of complex gassing systems can be time-consuming and burdensome, and can further add to the overall costs associated with a manufacturing process. Lastly, from a maintenance and use standpoint, improvements in conventional gassing systems, which overcome the drawbacks and disadvantages discussed above would likewise provide improvement in the durability of the various components associated therewith.

### SUMMARY OF INVENTION

The invention solves the problems and overcomes the deficiencies of the prior art gassing systems by providing novel gassing lance and gas control panel designs.

Thus, an aspect of the present invention is to provide a gassing lance which is compact, versatile and robust, and which can provide sufficient gas flow to quickly transmit or remove gas from a package without unnecessarily disturbing or contaminating the package contents, or contaminating the package seal.

Another aspect of the present invention is to provide a gassing lance which is capable of distributing multiple gas flow rates through multiple distinct channels into a package.

Yet another aspect of the present invention is to provide a gassing lance which is installable on a conventional forming tube of a Vertical Form Fill Seal machine.

Another aspect of the present invention is to provide a gassing lance which is relatively simple to manufacture, assemble and disassemble.

Yet another aspect of the present invention is to provide a gas control panel which is compact, versatile and robust, and which is capable of installation onto conventional packaging systems.

Another aspect of the present invention is to provide a gas control panel which is capable of reducing or virtually eliminating operator error by continuously monitoring and adjusting gas flow parameters as required, thereby maintaining specified gas parameters for a package.

Specifically, the invention provides a gassing lance including a base and an extension. The base may include a docking port connectable to an input member for transmitting gas to the gassing lance. The extension may include laminar gassing elements for transmitting gas through the gassing lance at a first flow rate and accelerator gassing elements for transmitting gas through the gassing lance at a second flow rate. The first flow rate may be less than the second flow rate.

For the gassing lance described above, the base may be removably connectable with the extension. The base may further include input and output laminar ports, input and output accelerator ports, and input and output analyzer ports. The docking port may likewise include input and output laminar ports, input and output accelerator ports, and input and output analyzer ports. When the docking port is connected to the base, the input laminar port, the input accelerator port and the output analyzer port on the base may be respectively interlinked with the output laminar port, the output accelerator port and the input analyzer port on the docking port, so as to enable the passage of gas between each of the respective input and output ports. The input member may include input and output laminar ports, input and output accelerator ports, and input and output analyzer ports. When the input member is connected to the docking port, the input laminar port, the input accelerator port and the output analyzer port on the docking port may be respectively interlinked with the output laminar port, the output accelerator port and the input analyzer port on the input member, so as to enable the passage of gas between each of the respective input and output ports.

The docking port may be removably connectable to the base. The docking port may include an externally threaded surface engageable with an internally threaded engagement section on the input member. The docking port may include guide holes engageable with respective locating pins on the input member. The extension may include first and second ends, the first end being removably connectable with the base.

The gassing lance may further include an accelerator tube including first and second ends. The first end of the accelerator tube may be connectable with the output accelerator port on the base and the second end of the accelerator tube may terminate substantially adjacent the second end of the extension. The accelerator tube may include holes having a central axis substantially orthogonal to a central axis of the accelerator tube. The accelerator tube may be removably connectable with the base by means of a set screw disposed in a threaded hole in the base. An end of the set screw may be engageable with the accelerator tube to connect the accelerator tube to the base. The accelerator tube may include an endpiece disposed adjacent the second end thereof. The endpiece may include an analyzer hole disposed substantially orthogonal to a gassing lance central axis. The analyzer hole may be interlinked with an output connector disposed on the endpiece. An analyzer tube may be connectable with the output connector to permit the transmission of gas from the analyzer hole to the input analyzer port on the base.

The laminar gassing element may be disposed substantially adjacent the second end of the extension on a surface of the extension for transmitting gas substantially perpendicular a gassing lance central axis. The accelerator gassing element may include first and second accelerator gassing elements. The first accelerator gassing element may be disposed substantially adjacent the second end of the extension on a surface of the extension for transmitting gas substantially perpendicular the gassing lance central axis. The second accelerator gassing element may be disposed substantially adjacent the second end of the extension on an end of the extension for transmitting gas substantially parallel to the gassing lance central axis. The surface area of the laminar gassing element may be greater than the surface area of either the first accelerator gassing element, or the second accelerator gassing element, or both. Spacers may be disposable adjacent the second end of the accelerator tube. The spacers may include first openings along the gassing lance central axis and second openings disposed substantially orthogonal to the gassing lance central axis. The first opening may permit transmission of gas substantially parallel to the gassing lance central axis and the second opening may permit transmission of gas substantially orthogonal to the gassing lance central axis. The gassing lance may further include baffle elements disposable adjacent the spacers for controlling transmission of gas through the first and second openings in the spacers. An endcap may be disposed adjacent the second end of the extension.

Each of the laminar and accelerator gassing elements may include wire meshes including microscopic holes enabling transmission of gas therethrough. The gassing lance cross section perpendicular to the gassing lance central axis may include a first generally curved surface and second generally flat surfaces. The curved surface may be disposable adjacent an inner surface of a forming tube when the gassing lance is mounted to the forming tube. The gassing lance may be mountable in a hole provided in the forming tube. When the gassing lance is mounted to the forming tube, the gassing lance docking port may protrude through the hole, and the gassing lance base and extension may be disposed inside the forming tube. The base may be disposed at an angle relative to the extension.

The invention further provides a method of supplying gas through a gassing lance disposable in a forming tube of a packaging machine. The gassing lance may include a base including a docking port connectable to an input member for transmitting gas to the gassing lance, and an extension. The extension may include laminar and accelerator gassing elements for transmitting gas through the gassing lance. The method may include the steps of connecting the input member to the docking port, transmitting gas through the laminar gassing element at a first flow rate, and transmitting gas through the accelerator gassing element at a second flow rate. The first flow rate may be less than the second flow rate.

For the method of supplying gas described above, the base may include input and output laminar ports, input and output accelerator ports, and input and output analyzer ports. Likewise, the docking port may include input and output laminar ports, input and output accelerator ports, and input and output analyzer ports. The method may further include the steps of connecting the docking port to the base, and thereby interlinking the input laminar port, the input accelerator port and the output analyzer port on the base with the output laminar port, the output accelerator port and the input analyzer port on the docking port, respectively, so as to enable the passage of gas between each of the respective input and output ports.

The input member may include input and output laminar ports, input and output accelerator ports, and input and output analyzer ports. The method may further include the step of interlinking the input laminar port, the input accelerator port and the output analyzer port on the docking port with the output laminar port, the output accelerator port and the input analyzer port on the input member, respectively, so as to enable the passage of gas between each of the respective input and output ports. An internally threaded engagement section on the input member may be engaged to an externally threaded surface of the docking port to connect the input member to the docking port. Locating pins may be provided on the input member for engagement with respective holes in the docking port. The holes may guide engagement of the docking port with the locating pins on the input member.

The extension may include first and second ends. The first end may be removably connectable with the base. An accelerator tube may be provided and may include first and second ends. The second end of the accelerator tube may terminate substantially adjacent the second end of the extension. The first end of the extension may be connected to the base, and the first end of the accelerator tube may be connected with the output accelerator port on the base. Holes may be provided in the accelerator tube. The holes may include a central axis substantially orthogonal to an axial length of the accelerator tube. The accelerator tube may be connected with the base by means of a set screw disposed in a threaded hole in the base. An end of the set screw may be engaged with the accelerator tube to connect the accelerator tube to the base. An endpiece disposed adjacent the second end of the accelerator tube may be provided. The endpiece may include an analyzer hole disposed substantially orthogonal to a gassing lance central axis. The analyzer hole may be interlinked with an output connector disposed on the endpiece. An analyzer tube may be connected with the output connector to permit the transmission of gas from the analyzer hole to the input analyzer port on the base.

The accelerator gassing element may include first and second accelerator gassing elements. The laminar gassing element may be disposed substantially adjacent the second end of the extension on a surface of the extension for transmitting gas substantially perpendicular a gassing lance central axis. The first accelerator gassing element may be disposed substantially adjacent the second end of the extension on a surface of the extension for transmitting gas substantially perpendicular the gassing lance central axis. The second accelerator gassing element may be disposed substantially adjacent the second end of the extension on an end of the extension for transmitting gas substantially parallel to the gassing lance central axis. The surface area of the laminar gassing element may be greater than the surface area of the first accelerator gassing element or the second accelerator gassing element, or both.

Spacers may be disposed adjacent the second end of the accelerator tube. The spacers may include first openings disposed along the gassing lance central axis and second openings disposed substantially orthogonal to the gassing lance central axis. The first opening may permit transmission of gas substantially parallel to the gassing lance central axis and the second openings may permit transmission of gas substantially orthogonal to the gassing lance central axis. Baffle elements may be disposed adjacent the spacers for controlling transmission of gas through the first and second openings in the spacers. An endcap may be disposed adjacent the second end of the extension.

A plurality of microscopic holes may be provided in each of the laminar and accelerator gassing elements for enabling transmission of gas therethrough. The gassing lance cross section perpendicular to the gassing lance central axis may include a first generally curved surface and at least one second generally flat surface. The curved surface may be disposed adjacent an inner surface of a forming tube when the gassing lance is mounted to the forming tube. The gassing lance may be mounted in a hole provided in the forming tube. The gassing lance docking port may protrude through the hole, and the gassing lance base and extension may be disposed inside the forming tube. The base may be disposed at an angle relative to the extension.

The invention yet further provides a gas control panel for controlling and directing gas flow. The gas control panel may include first circuits for controlling gas flow at a first flow rate through one or more gassing lances. An operator interface may be provided for setting forth a desired gas characteristic. A gas analyzer may be provided for measuring a gas characteristic for gas flowing through the gassing lances. The gas characteristic may constitute a measured gas characteristic, and correspond either directly or indirectly to the desired gas characteristic. A control system, namely a Programmable Logic Control may be provided for controlling the first circuit such that the measured gas characteristic corresponds to the desired gas characteristic.

The gas control panel may further include second circuits for controlling gas flow at a second flow rate through the gassing lances. The Programmable Logic Control may control the first and second circuits such that the measured gas characteristic corresponds to the desired gas characteristic. The first flow rate may be less than the second flow rate. Gas may be supplied to the gas control panel via a gas supply. A filter-regulator may be provided for filtering and regulating flow of gas from the gas supply. A gas distribution manifold may be provided for distributing gas supplied from the filter-regulator to the first and second circuits.

For the gas control panel described above, the first circuit may include an electronic pressure regulator for increasing or decreasing gas flow controlled by the first circuit based upon a gas flow reading by a flow indicator. The flow indicator may be connected in series between the electronic pressure regulator and a solenoid valve. The second circuit may likewise include an electronic pressure regulator for increasing or decreasing gas flow controlled by the second circuit based upon a gas flow reading by a flow indicator. The flow indicator may be connected in series between the electronic pressure regulator and a solenoid valve.

The gas characteristic measured by the gas analyzer may be converted into a deliverable gas flow via a control scheme. Exemplary control schemes may include PID, Speed, Minimum, Maximum, Linear or Logarithmic, which may be utilized singly or in combination.

During operational or non-operational states of a packaging machine, the first and second flow rates may be either constant, pulsed, dependent upon an operational speed of the packaging machine, dependent upon an operational state of the packaging machine, or variable. Alternatively, the first and second flow rates may be combinations of the above-identified flow rate. The first and second flow rates may be increased or decreased based upon the gas characteristic measurement. The Programmable Logic Control may be programmed for a plurality of flow rates corresponding to the desired gas characteristics.

The invention further provides yet another gas control panel for controlling and directing gas flow. The gas control panel may include a plurality of circuits for controlling gas flow at a plurality of flow rates. An operator interface may be provided for setting forth desired gas characteristics. A gas analyzer may be provided for measuring gas characteristics of gas directed by the gas control panel. The gas characteristics may constitute measured gas characteristics and correspond either directly or indirectly to the desired gas characteristics. A Programmable Logic Control may be provided for controlling the circuits such that the measured gas characteristics correspond to the desired gas characteristics.

The invention further provides a method of controlling and directing gas flow. The method may include the steps of providing first circuits for controlling gas flow at a first flow rate through one or more gassing lances, setting forth a desired gas characteristic, and measuring a gas characteristic for gas flowing through the gassing lances. The gas characteristic may constitute a measured gas characteristic and correspond either directly or indirectly to the desired gas characteristic. The method may yet further include the step of controlling the first circuit such that the measured gas characteristic corresponds to the desired gas characteristic.

For the method described above, second circuits may be provided for controlling gas flow at a second flow rate through the gassing lances. The first and second circuits may be controlled such that the measured gas characteristic corresponds to the desired gas characteristic. The first flow rate may be less than the second flow rate. Gas from a gas supply may be filtered and regulated, and distributed to the first and second circuits. The gas flow controlled by the first and second circuits may be increased or decreased based upon a gas flow reading. The measured gas characteristic may be converted into a deliverable gas flow via a control scheme. Exemplary control schemes include PID, Speed, Minimum, Maximum, Linear or Logarithmic, which may be utilized singly or in combination.

During operational or non-operational stages of a packaging machine, the first and second flow rates may be either constant, pulsed, dependent upon an operational speed of the packaging machine, dependent upon an operational state of the packaging machine, or variable. Alternatively, the first and second flow rates may be combinations of the above-identified flow rates. Lastly, the first or second flow rates may be increased or decreased based upon the gas characteristic measurement.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a front view of a gassing lance according to the present invention;

FIG. 2 is a side view of the gassing lance of FIG. 1;

FIG. 3 is a back view of the gassing lance of FIG. 1;

FIG. 4 is an end view of the gassing lance of FIG. 1, illustrating an accelerator flow port, taken along direction 4-4 in FIG. 1;

FIG. 5 is a sectional view of the gassing lance of FIG. 1, taken along section 5-5;

FIG. 6 is a perspective view of a spacer which may be used to align the gassing lance of FIG. 1 relative to a forming tube;

FIG. 7 is a perspective view of an exemplary retaining nut which may be used to affix the gassing lance of FIG. 1 onto a forming tube;

FIG. 8 is a front enlarged view of a baffle element for the gassing lance of FIG. 1;

FIG. 9 is a front enlarged view of a spacer which may be used to separate the baffle element of FIG. 8;

FIG. 10 is an enlarged perspective view of an endcap for the gassing lance of FIG. 1;

FIG. 11 is an enlarged view of the spacer of FIG. 9, taken along direction 11-11 in FIG. 9;

FIG. 12 is an enlarged view of the spacer of FIG. 9, taken along direction 12-12 in FIG. 9;

FIG. 13 is an enlarged end view of the gassing lance of FIG. 1, taken along direction 4-4, with the endcap of FIG. 10, baffle elements of FIG. 8 and the spacer of FIG. 9 removed;

FIG. 14 is an enlarged perspective view of a retention element for retaining the baffle elements of FIG. 8 and the spacer of FIG. 9;

FIG. 15 is an illustrative side view of an accelerator flow tube;

FIG. 16 is an enlarged perspective view of the gassing lance base;

FIG. 17 is an enlarged perspective view of a quick connect, illustrating the flexible tubes for providing gas for laminar and accelerator flow, and for gas analysis;

FIG. 18 is an illustrative perspective view of the gassing lance installed onto a forming tube, with the docking port of the gassing lance protruding through a hole in the forming tube;

FIG. 19 is a rotated enlarged perspective view of the quick connect of FIG. 17, illustrating the locating pins and engagement areas of the quick connect;

FIG. 20 is a cutout view of the gassing lance of FIG. 2, illustrating the layout of various internal components;

FIG. 21 is a front view of the accelerator tube of FIG. 15, illustrating the location of an output connector for the flexible gas analyzer tube;

FIG. 22 is a front view of a forming tube including a plastic bag installed thereon;

FIG. 23 is a front view of a first embodiment of a related art gas control panel which has been designed, manufactured and utilized herewith;

FIG. 24 is a front view of the top-most and middle internal components of the gas control panel of FIG. 23;

FIG. 25 is a front view of the bottom-most internal components of the gas control panel of FIG. 23;

FIG. 26 is a front view of the internal components of a second embodiment of a related art gas control panel which has been designed, manufactured and utilized herewith;

FIG. 27 is a front view of a third embodiment of a gas control panel according to the present invention; and

FIG. 28 is a front view of the internal components of the gas control panel of FIG. 27.

### DETAILED DESCRIPTION OF THE PREFERRED EMBODIMENT

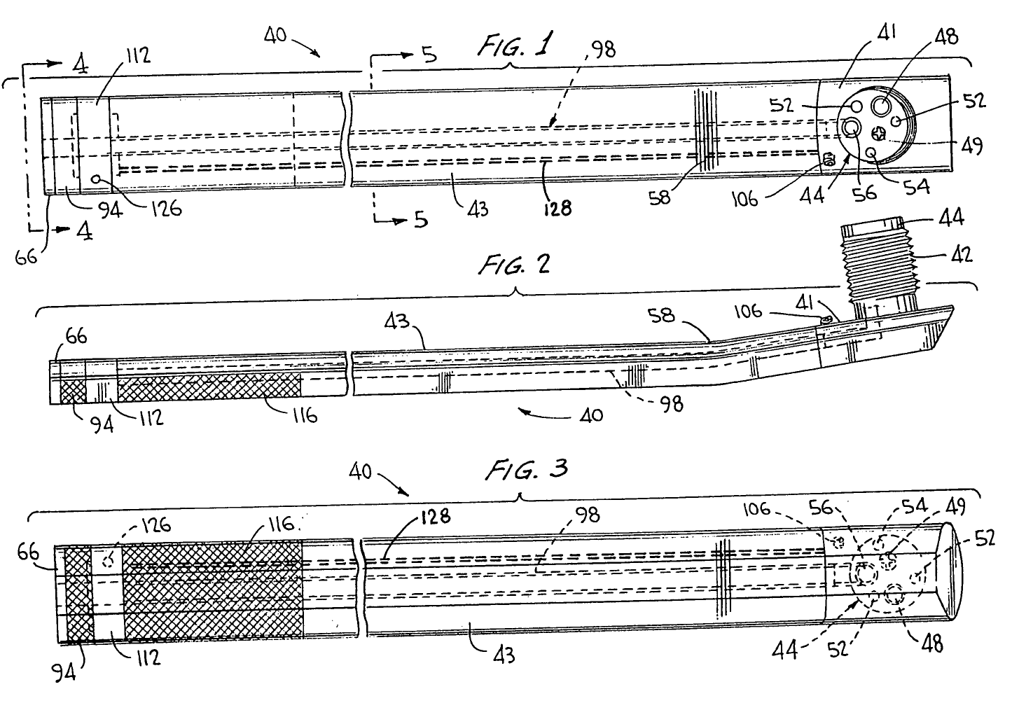

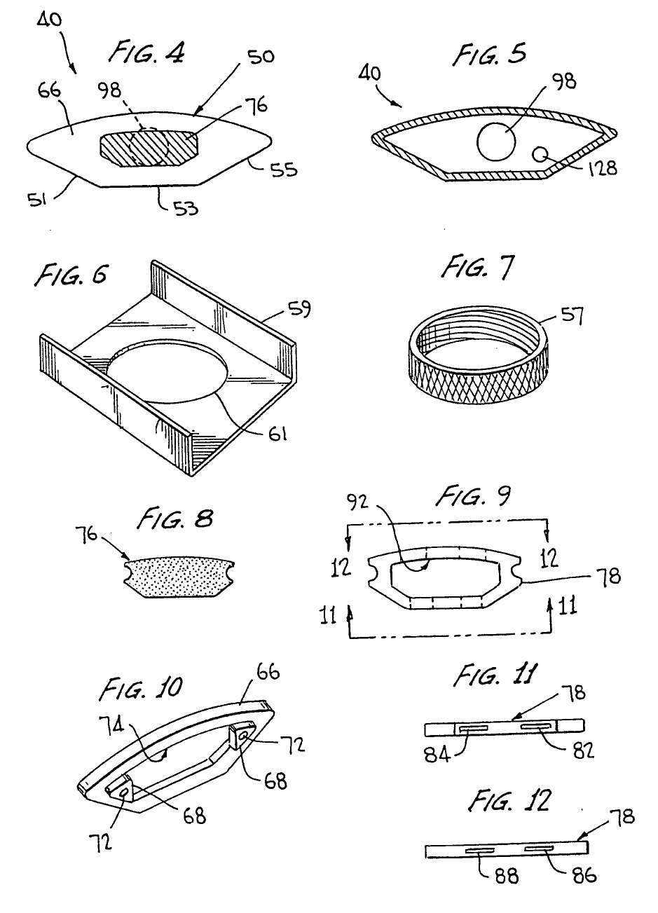

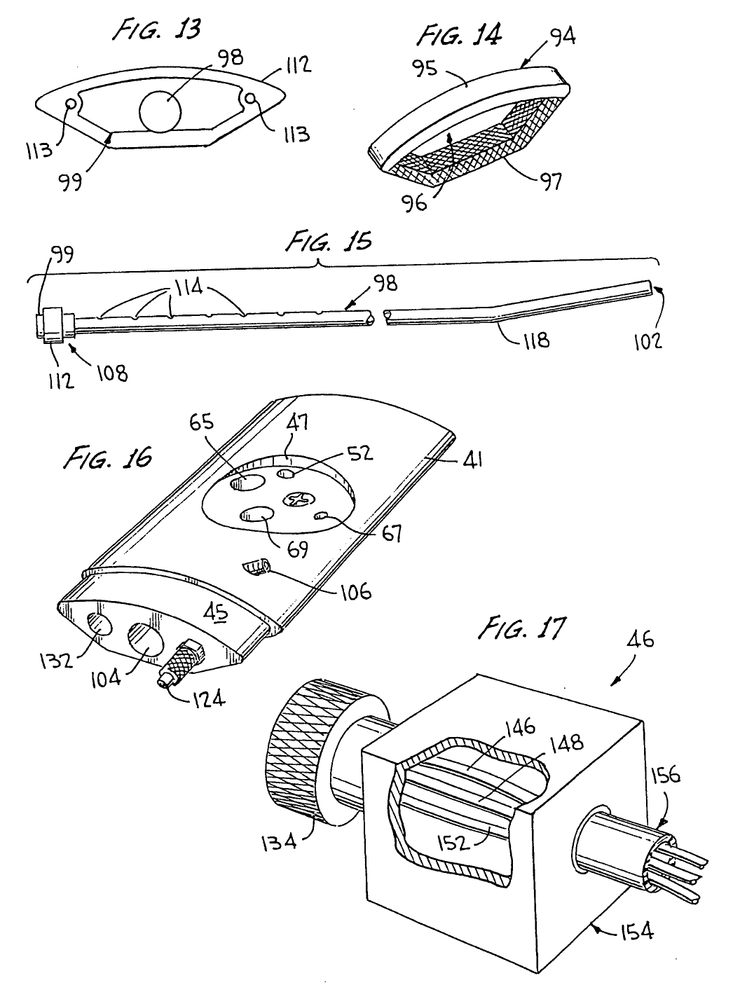

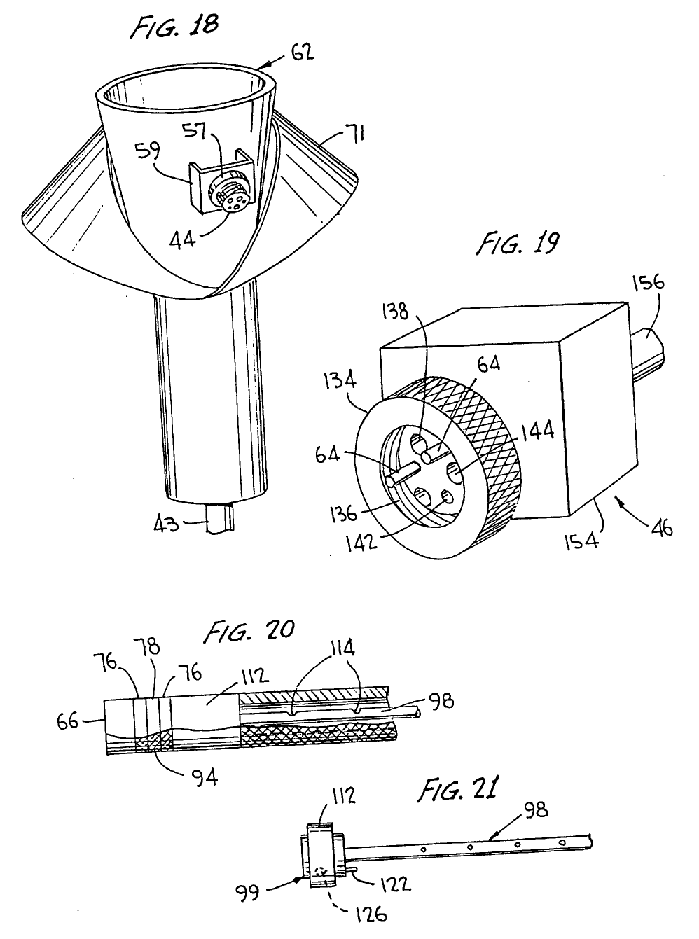

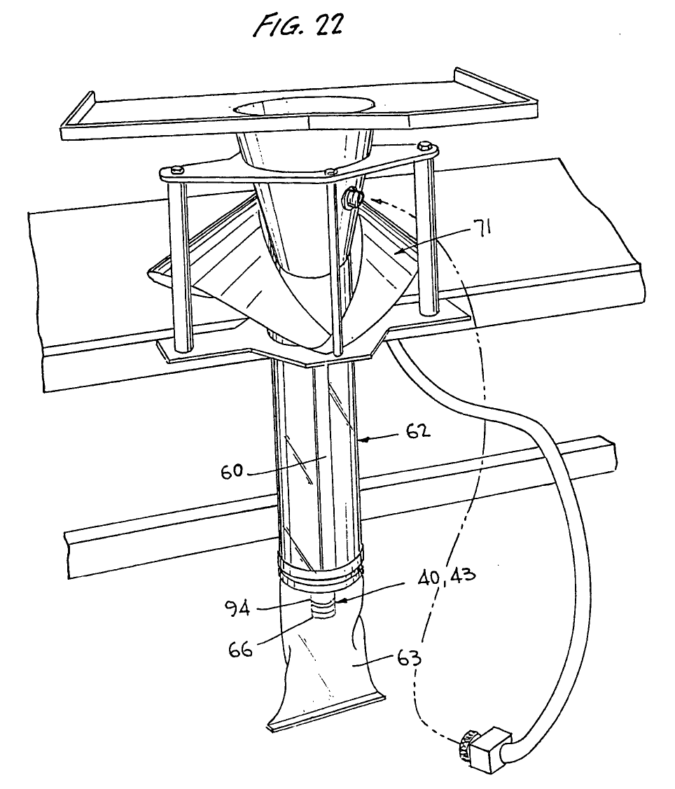

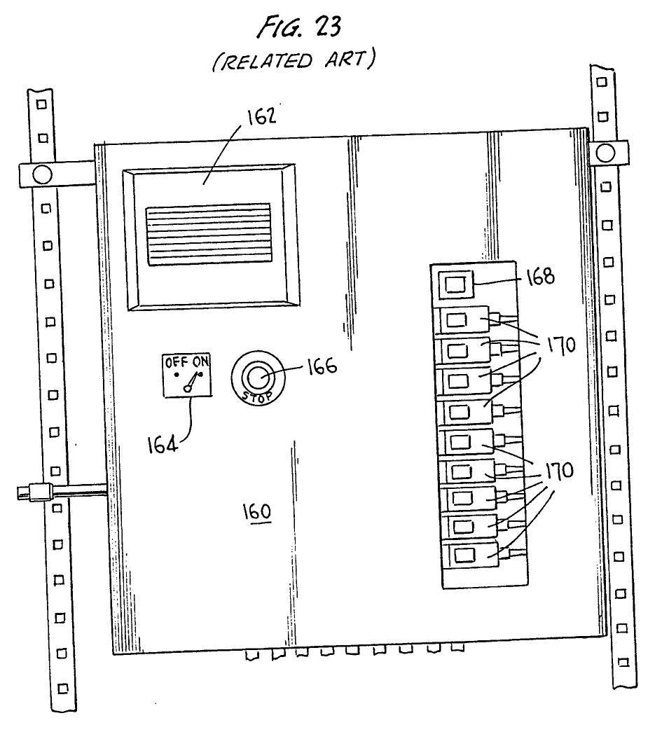

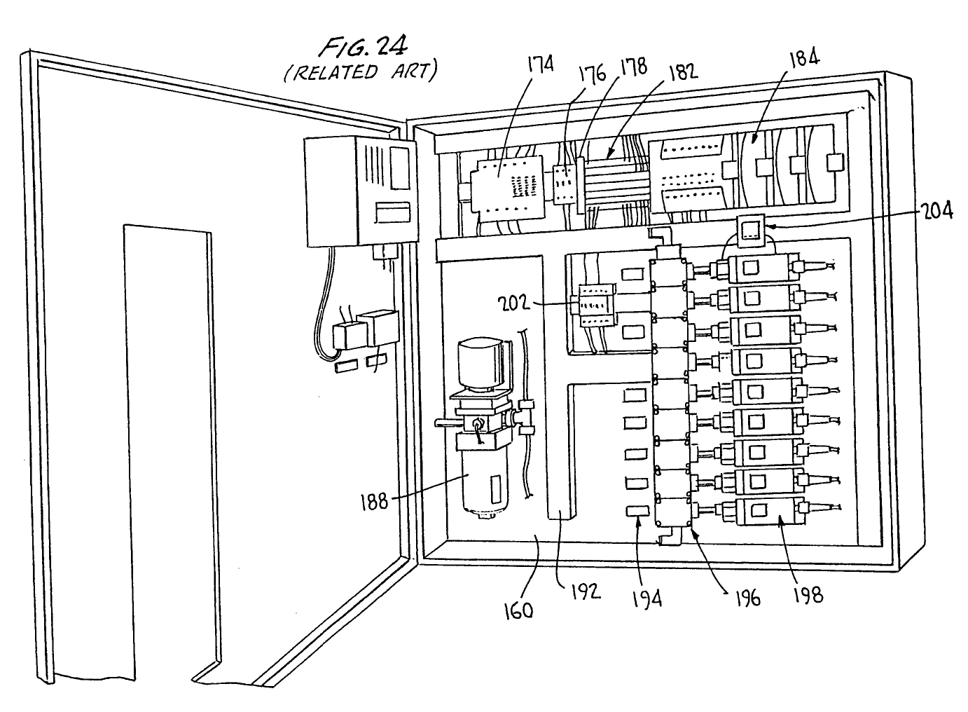

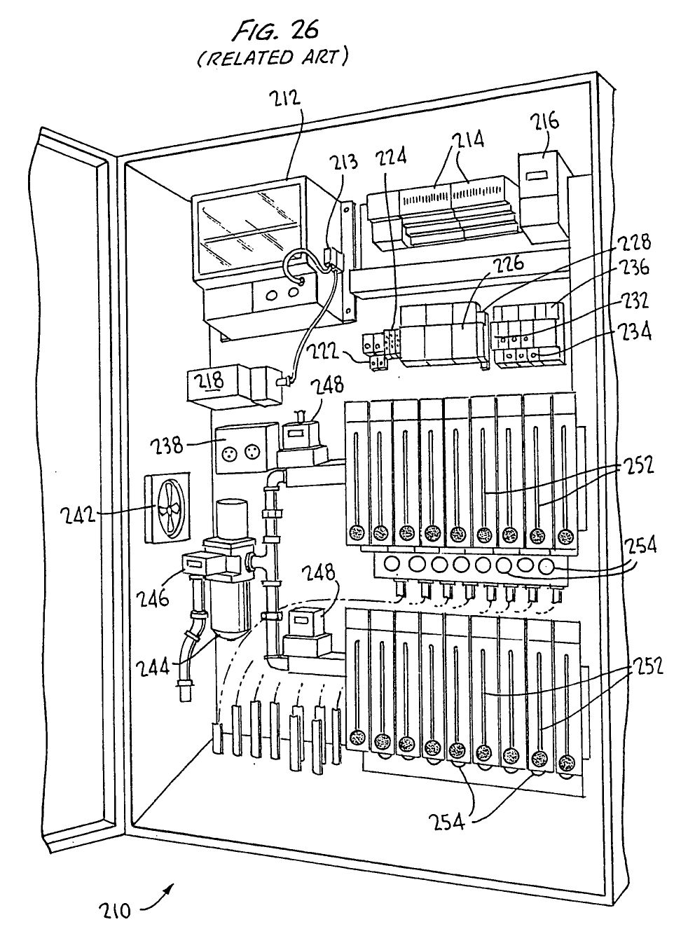

Referring now to the drawings wherein like reference numerals designate corresponding parts throughout the several views, FIGS. 1-22, 27 and 28 illustrate components of a gassing lance system according to the present invention. The gassing lance system may include a gassing lance 40, generally illustrated in FIGS. 1-22, and a gas control panel 260, generally illustrated in FIGS. 27 and 28.

Generally, the gassing lance system according to the present invention is a gas flushing system which may be installed in a conventional Vertical Form Fill Seal (VFFS) machine (not shown). Gassing lance 40 may be installed inside a forming tube (i.e. forming tube 62 described below) of a packaging machine (not shown) so as to deliver gas relatively close to the sealing bar of the packaging machine. Gas control panel 260 may be used to control and deliver the desired gas to gassing lance 40.

Referring now to FIGS. 1-3 and 16, gassing lance 40 may include a gassing lance base 41 (hereinafter “base”) and a gassing lance extension 43 (hereinafter “extension”). Base 41 may be removably connectable with extension 43. A seal 45 may be provided on base 41, as illustrated in FIG. 16, and/or in extension 43 for sealing the interconnection between the two members. Additionally, the interconnection area between base 41 and extension 43 may be bent at section 58 for facilitating alignment of gassing lance 40 with forming tube 62 (described below). An indented section 47 may be provided in base 41 for facilitating alignment of a docking port 44 (described below).

As shown in FIG. 4, base 41 and extension 43 may each include a curved profile 50 on one face thereof, and an angled profile, including first, second and third surfaces 51, 53 and 55, on the other face thereof. The face including curved profile 50 may be directed toward the inner wall surface of forming tube 62, and the angled profile face may be directed toward the center of forming tube 62.

Referring to FIGS. 1, 2, 6, 7, 18, 19 and 22, a docking port 44 for connection of a quick connect 46 (described below) may be provided on base 41. Docking port 44 may include a connector 49, such as a screw or the like, for retention thereof onto base 41 of gassing lance 40. Docking port 44 may further include a laminar gas port 48, holes 52 for insertion of locating pins 64 (described below) provided in quick connect 46, analyzer gas port 54 and accelerator gas port 56. Laminar gas port 48, analyzer gas port 54 and accelerator gas port 56 may each include an o-ring for sealing the connection with laminar, analyzer and accelerator gas ports 138, 142 and 144 (described below), respectively, of quick connect 46. In order to obtain a reliable gas reading, analyzer gas port 54 must be sealed off completely. As discussed in greater detail below, analyzer gas port 54 allows gas control panel 260 (described below) to verify that the gas in the proximity of exemplary package 63, shown in FIG. 22, is at the desired level prior to sealing thereof. The outer surface of docking port 44 may include threads 42, as shown in FIG. 2, for permitting locking nut 57 to be threadedly engaged thereto. It is foreseeable that other means of providing a quick-connect feature for attachment of gas to docking port 44 may also be used. A spacer 59, including a hole 61 for permitting insertion of docking port 44 therethrough, may be used to fasten gassing lance 40 securely to forming tube 62.

Referring to FIGS. 1, 4 and 10, an endcap 66 may be provided at an end of extension 43 (i.e. left side of FIG. 1). Endcap 66 may include projections 68 including threaded holes 72 for insertion of fasteners, such as screws, for securing endcap 66 to gassing lance 40. A cutout 74 may be provided in endcap 66 for permitting exit of accelerator gas flow therethrough.

Referring to FIGS. 4, 8, 9 and 20, a baffle element 76 may be provided between endcap 66 and each side face of a spacer 78 (described below) for controlling the velocity of accelerator flow exiting through gassing lance 40. Baffle element 76, which permits the exit of accelerator flow therethrough, may constitute a first accelerator gassing element. Baffle element 76 may include a plurality of meshed porous screens disposed in a layered configuration. Layering the screens for baffle element 76 allows for control of the flow velocity exiting therethrough, in conjunction with the gas pressure.

Referring to FIGS. 9, 11, 12 and 20, as discussed above, a spacer 78 may be provided between baffle elements 76. Spacer 78 may include an opening 92 and additional openings 82, 84, 86 and 88, provided orthogonal to opening 92, for permitting passage of accelerator flow therethrough. It is foreseeable that other opening configurations may also be used.

Referring to FIGS. 1, 14, 15, 20 and 21, a retention element 94 may be provided for enclosing and retaining baffle elements 76 and spacer 78. Retention element 94 may include a cutout 96 sized to retain baffle elements 76 and spacer 78 therein. Additionally cutout 96 may be sized to fit over section 99 of end-piece 112 (described below). Retention element 94 may further include a curved face 95 on one side thereof, and an angled face 97, constituting a second accelerator gassing element, on the other side thereof. Curved face 95 may be made of a non-porous material, such as stainless steel and the like. Angled face 97 may be made of one or more meshed screens similar in construction to baffle element 76 for permitting transmission of some of the accelerator flow therethrough.

As shown in FIGS. 1-3, 13, 15, 16 and 20, an accelerator tube 98 may be provided in gassing lance 40 to transmit gas from accelerator gas port 56 and out through the outermost baffle element 76 (i.e. first accelerator gassing element). Accelerator tube 98 may include a first end 102 which may be inserted into accelerator output port 104 in base 41. Accelerator output port 104 may be interlinked with accelerator gas port 69 in base 41. A set-screw 106 provided in base 41 may be used to secure accelerator tube 98 to base 41. It is foreseeable that other retention means for accelerator tube 98 may also be provided. A second end 108 of accelerator tube 98 may include an end-piece 112. Accelerator tube 98 may be welded to end-piece 112, or attached thereto by other means known in the art. A plurality of spaced holes 114 may be provided in accelerator tube 98 for permitting some of the gas in accelerator tube 98 to enter into gassing lance 40 and exit through laminar gassing element 116. Since the majority of accelerator flow exits through baffle element 76, holes 114 reduce the velocity of the overall accelerator flow by distributing the excess pressure in accelerator tube 98 into the open area inside gassing lance 40. It is apparent that the number of holes 114 may be increased or decreased to vary the amount of laminar flow needed through laminar gassing element 116, or to increase or decrease the amount of accelerator flow through angled face 97 of retention element 94. A bent section 118 may be provided in accelerator tube 98 for facilitating insertion of accelerator tube 98 into gassing lance 40 adjacent bent section 58. Accelerator tube 98 may be made of a metal, such as stainless steel, or other similar materials.

As shown in FIGS. 10, 13, and 20, end-piece 112 may include holes 113 through which fasteners (not shown), such as screws, may be inserted for attachment of end-piece 112 to endcap 66. It is apparent that the fasteners may be screwed on or otherwise connected into threaded holes 72 of endcap 66 to retain baffle elements 76 and spacer 78 therebetween.

Referring next to FIGS. 1, 3, 5, 16 and 20-22, a flexible gas analyzer tube 128 may be connected at one end thereof to an output connector 122 mounted to end-piece 112, and the other end thereof to an input connector 124 on base 41. Input connector 124 may be interlinked with analyzer gas port 67 on base 41. Additionally, a gas analysis hole 126 may be strategically located as shown on FIG. 1 and interlinked with output connector 122. The location of gas analysis hole 126, as shown in FIG. 1, is rather critical for obtaining reliable gas readings in the proximity of package 63. If gas analysis hole 126 is not strategically located as shown in FIG. 1, the reading thereof may be more substantially influenced by factors such as the laminar and accelerator flow in package 63.

Referring to FIG. 16, laminar gas port 65 in base 41 may be interlinked with laminar output port 132. In the embodiment of FIG. 16, gas may exit through laminar output port 132 into the body of lance 40. It is apparent however that a tube, similar in construction to accelerator tube 98, may be affixed to laminar output port 132 to transmit gas from port 132 and out through laminar gassing element 116. Additionally, laminar, analyzer and accelerator gas ports 65, 67 and 69, respectively, on base 41, may each include o-rings for sealing the interconnection with laminar, analyzer and accelerator gas ports 48, 54 and 56, respectively, in docking port 44.

The flow output through laminar gassing element 116 and retention element 94, which provides accelerator flow therethrough, may generally be perpendicular to forming tube 62. It is apparent that gassing lance 40 may be configured such that the majority of accelerator flow may exit through baffle element 76. It is also apparent that by distributing the accelerator flow through two outlets (i.e. retention element 94 and baffle elements 76), the overall velocity of the accelerator flow exiting through baffle element 76 is reduced.

In a particular embodiment of gassing lance 40, gas output through laminar gassing element 116 provides the initial volume for filling a package 63 and the accelerator flows through the angled face 97 of retention element 94 and baffle element 76 act to maintain the volume before sealing package 63. The benefit of the laminar and accelerator flows is realized when packages of different volumes are filled. Speed parameters for filling packages and flow rate parameters of accelerator and laminar flow vary for the gassing lance system and are dependent upon the size of the package being filled. For example, in a typical packaging situation, the accelerator flow rate may be twice the laminar flow rate. For a forming tube 62 having a length of 35″, exemplary dimensions for gassing lance 40 may include an overall length of 36″, a width of 2″, a laminar gassing element having a length of 5″ along the axis of gassing lance 40 and a retention element 94 (for accelerator flow) having a length of 0.4″ along the axis of gassing lance 40.

Referring next to FIGS. 1, 2 and 17-19, quick connect 46 may be provided with an internally threaded engagement section 134, for engagement with docking port 44. Specifically, engagement section 134 may include complementary internal threads 136 for engagement with external threads 42 on docking port 44. Laminar and accelerator gas ports 138 and 144, respectively, in quick connect 46, may be provided for transmitting gas to laminar gas port 48 and accelerator gas port 56, respectively, in docking port 44. Additionally, analyzer gas port 142 in quick connect 46, may be provided for transmitting gas from analyzer gas port 54 in docking port 44. Laminar, analyzer and accelerator gas ports 138, 142 and 144, respectively, in quick connect 46, and laminar gas port 48, analyzer gas port 54 and accelerator gas port 56, respectively, in docking port 44, may each include o-rings for sealing the interconnection therebetween. Flexible tubes 146, 148 and 152 may be connected to laminar, analyzer and accelerator gas ports 138, 142 and 144, respectively, disposed in housing 154, and exit through a single conduit 156. Tubes 146, 148 and 152 may be connected to gas supplies and a gas analyzer, as described below. It is foreseeable that other means may be utilized for providing a quick-connect to docking port 44 for supplying gas to gassing lance 40.

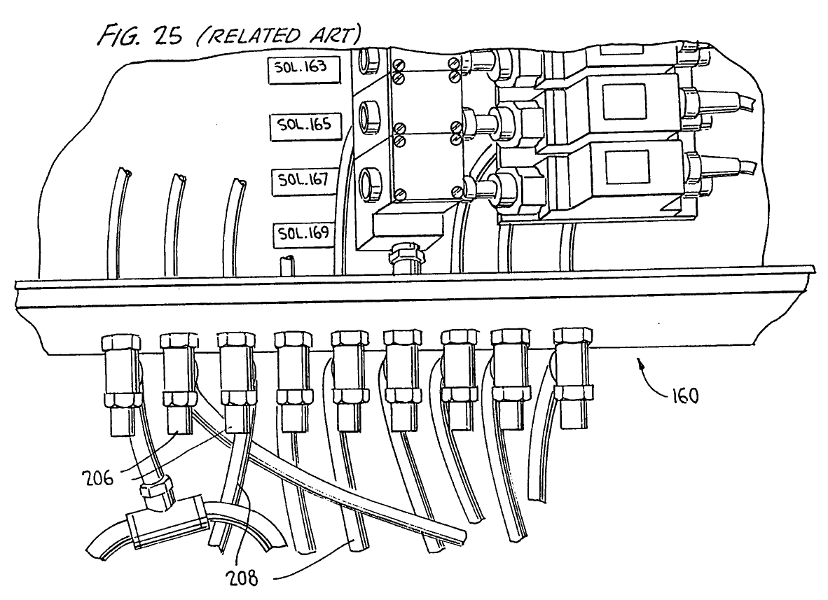

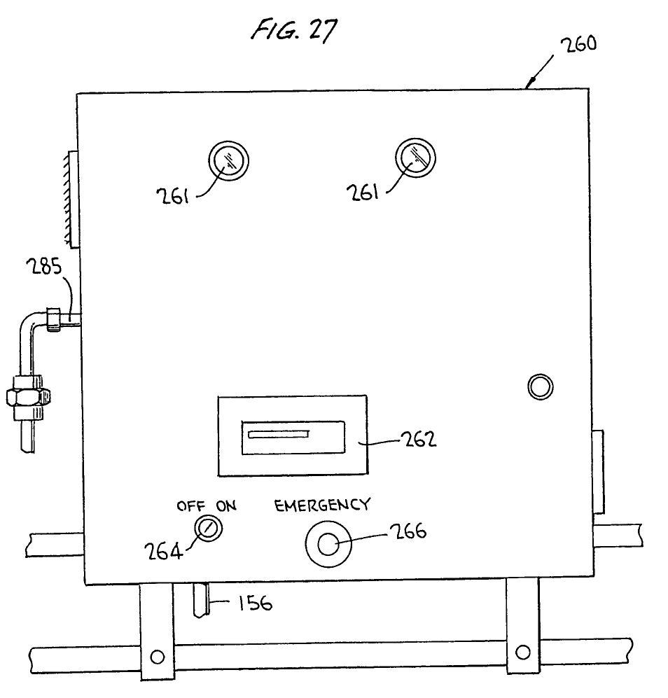

Referring to FIGS. 18 and 22, gassing lance 40 may be disposed inside forming tube 62 of a conventional packaging machine (not shown) and extend through forming tube 62 so that the gas delivery areas (i.e. baffle element 76, angled face 97 of retention element 94 and laminar gassing element 116) are relatively close to the sealing bar of the packaging machine. In a conventional operation, forming tube 62 may take film from a roll (not shown) and run it over shoulders 71. The film may be folded into a round bag or tube having some overlap for the film. TEFLON tape 60 may be used to provide a sealing surface for heat-sealing a part of package 63. As shown in FIGS. 18 and 23, the portion of extension 43 (i.e. endcap 66 and retention element 94) of gassing lance 40 may protrude out through the opening in forming tube 62 to transmit gas into a package 63. It is foreseeable that gassing lance 40 may not protrude through forming tube 62 if the length of forming tube 62 is greater than that of gassing lance 40.

Gassing lance 40, and the various components thereof described above, may be made of metals, such as stainless steel or aluminum, or other similar materials, or may be made of plastics, composites and other similar materials. Additionally, it is apparent from the above discussion that gassing lance 40 according to the present invention may be quickly assembled and disassembled for sanitation or for changeover purposes. Alternatively, the number of components of gassing lance 40 may be reduced by welding, for example. Such a reduction may make sanitation more difficult, but would render gassing lance 40 less expensive to manufacture.

A gas control panel 260 according to the present invention, for transmitting and controlling the flow of gas to gassing lance 40, will now be described in detail. However, before proceeding with the description of gas control panel 260, in order to illustrate the novelty of gas control panel 260, gas control panels 160 and 210, which have been designed, manufactured and utilized herewith, and briefly described in the section titled “Description of Related Art,” will first be described in detail.

Referring now to FIGS. 23-25, a first embodiment of a gas control panel 160 according to the present invention will now be described in detail.

Gas control panel 160 for use in a pharmaceutical line, for example, may include an operator interface 162, a power on switch 164, an emergency stop switch 166, a pressure indicator/switch 168 and flow indicators/switches 170. In the embodiment of FIG. 23, nine flow indicators/switches 170 are illustrated. It is however apparent that the number of flow indicators/switches 170 may correspond to the number of flow control valves 206.

As shown in FIGS. 24 and 25, the front door of gas control panel 160 is shown in an open configuration to illustrate the various internal components thereof. Referring to FIGS. 24 and 25, gas control panel 160 may further include a power supply 174, fuse terminals 176, grounding terminals 178, electronic terminals 182 and a Programmable Logic Control (PLC) 184 with I/O modules. Gas control panel 160 may further include a filter/regulator 188, wiring duct 192, phenolic tags 194, gas distribution manifolds with solenoid valves 196 and flow indicators/switches 198. Gas control panel 160 may yet further include electrical terminals 202 and pressure indicator/switch 204.

Referring next to FIG. 25, a plurality of manual flow control valves 206 having gas distribution hoses 208 attached thereto may also be provided in gas control panel 160.

In operation, if flow through the gas distribution hoses drops below a predetermined limit, flow indicators/switches 198 may be configured to sound an alarm. Manual flow control valves 206 may then be manually adjusted to increase or decrease the amount of flow, and to therefore obtain a desired gas environment in exemplary package 63, shown in FIG. 22 or at some other place.

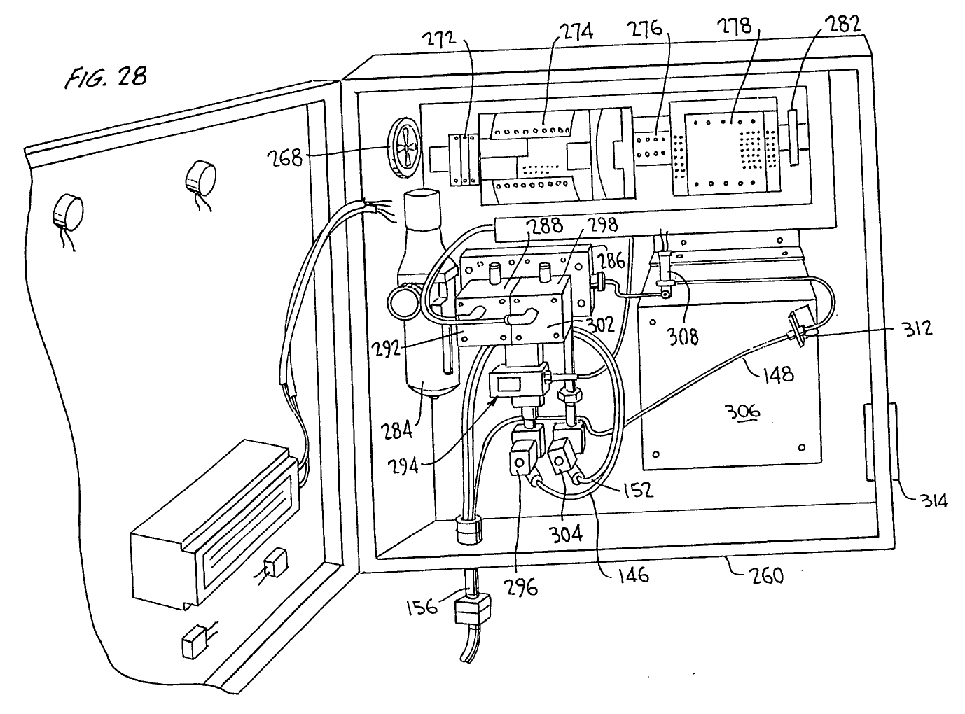

Referring now to FIG. 26, a second embodiment of a gas control panel 210 according to the present invention will now be described in detail.

Gas control panel 210 for use in a food processing line, for example, may include a gas analyzer 212. Gas analyzer 212 may include solenoid valves 213 mounted on a side thereof to allow switching to different ports. Allen-Bradley Flex I/O modules 214 and a SOLA power supply 216 may be provided adjacent gas analyzer 212. It is foreseeable that other manufacturers may be employed to communicate with a Programmable Logic Control or other components of Gas control panel 210.

Gas control panel 210 may further include an auxiliary sample pump 218, circuit breakers 222, relays 224, terminals 226, an optoisolator 228, a relay 232, circuit breakers 234 and terminals 236.

Gas control panel 210 may yet further include a duplex receptacle 238 for 110VAC power, a fan 242 located under duplex receptacle 238, and a filter/regulator 244. In the embodiment of FIG. 26, filter/regulator 244 may include a pressure indicator/switch 246 mounted thereon. Electronic pressure regulators 248 may be provided to regulate the gas pressure. Additionally, one or two units, each including nine point distribution manifold assemblies with manual flow control valves 252 and solenoid valves (not shown) may be provided. Each of the manifold assemblies may include valves 254 between each outlet port.

Referring now to FIGS. 27 and 28, a third embodiment of a gas control panel 260 according to the present invention will now be described in detail.

As shown in FIG. 27, gas control panel 260 may include indicator lights 261 showing the status of gas control panel 260, an operator interface 262, a power on switch 264, an emergency stop switch 266, and a gas supply 285. The wiring layout for indicator lights 261, operator interface 262, power on switch 264, and emergency stop switch 266 is shown in FIG. 28.

As shown in FIGS. 27 and 28, the front door of gas control panel 260 is shown in an open configuration to illustrate the various internal components thereof. Referring to FIG. 28, gas control panel 260 may further include a cooling fan 268 for cooling the various electronic components therein, optoisolators 272, a Programmable Logic Control 274 for controlling the various electronic components therein, terminals 276, a power supply 278 and terminals 282. Gas control panel 260 may further include a filter/regulator 284 for the desired gas and a gas distribution manifold 286. Filter/regulator 284 may be connected between gas supply 285 and gas distribution manifold 286. A left circuit 288 may be provided on gas distribution manifold 286 for laminar flow. Left circuit 288 may include an electronic pressure regulator 292, a flow indicator 294 with analog and/or switch output in the middle thereof, and a solenoid valve 296 on the bottom. Flow indicator 294 may be connected in series between electronic pressure regulator 292 and solenoid valve 296. Additionally, a manual flow restrictor valve can be placed in series. A right circuit 298 may be provided on gas distribution manifold 286 for accelerator flow. Right circuit 298 may include an electronic pressure regulator 302, and a solenoid valve 304 on the bottom. Additionally, a manual flow restrictor valve can be placed in series. Gas control panel 260 may further include a gas analyzer 306, a blow-off solenoid 308 adjacent a left surface of gas analyzer 306, an inline filter 312 adjacent a right surface of gas analyzer 306, and an inlet air filter 314. Provisions may also be made to switch gas analyzer 306 to other ports using additional solenoid valves (not shown). Moreover, although not illustrated in FIGS. 27 and 28, as discussed above for left circuit 288, right circuit 298 may also include a flow indicator (not shown) with analog and/or switch output in the middle thereof, the flow indicator being connected in series between electronic pressure regulator 302 and solenoid valve 304.

Referring to FIGS. 1, 16, 17 and 28, flexible tubes 146, 148 and 152, connected to laminar, analyzer and accelerator gas ports 138, 142 and 144, respectively, of quick connect 46, may be connected to solenoid valve 296, inline filter 312 (connected to gas analyzer 306), and solenoid valve 304, respectively, and exit through the single conduit 156.

Referring to FIGS. 1 and 28, gas analyzer 306 may measure the purity of the gas through gas analysis hole 126 in end-piece 112. In operation, gas analyzer 306 may continuously draw a sample of the environment in the open space near a package (i.e. package 63 in FIG. 22). The gas reading may then be displayed on operator interface 262. This gas reading may be converted into a deliverable gas flow via a PID loop or other control schemes. The accelerator flow may be used in a pulsed mode, for example. The laminar flow may be compensated based upon the gas reading. In addition to being used for verification of the gas near package 63, the gas reading by gas analyzer 306 may also be used to provide an operator with statistical information and related analysis of the operational characteristics of the gassing lance system (i.e. gassing lance 40 and gas control panel 260), as well as for checking individual sealed packages.

In operation, flow indicator 294 may continuously provide a reading of the amount of gas flow in laminar tube 146 by using the analog I/O. This reading may then be sent to laminar electronic pressure regulator 292, to increase or decrease the pressure in laminar tube 146. Based upon the increased or decreased pressure, as discussed above, flow indicator 294 may continuously provide a reading of the amount of gas flow in laminar tube 146. Accordingly, by continuously monitoring the amount of gas flow in laminar tube 146, and continuously increasing or decreasing the pressure in laminar tube 146, gas control panel 260 may attain and thereafter maintain a specified gas environment near a package (i.e. package 63). It is apparent that since the accelerator gas flow is generally pulsed, in order to adjust the gas environment near package 63, for general applications of gassing lance 40 of the present invention, it may only be necessary to monitor and control the pressure in laminar tube 146. It is however evident that if needed, the gas flow in accelerator tube 152 may also be monitored and controlled by an additional flow switch.

The operation of the various electronic components of gas control panel 260 discussed above may be controlled by Programmable Logic Control 274. Programmable Logic Control 274 may be programmed to remember a host of flow rates for specific operations and respond accordingly. This type of setup allows different “recipes” to be programmed into Programmable Logic Control 274, based upon the type of product, container size, running speed, etc.

As illustrated in FIGS. 23-26 for gas control panels 160 and 210, it is apparent that the number of components connected to a specific gassing lance 40 for gas control panel 260 may be duplicated as needed for configuring gas control panel 260 for operating multiple gassing lances 40 or for controlling gas to other types of devices (not shown).

Referring to FIG. 28, the laminar and accelerator flows through flexible tubes 146 and 152, respectively, may be controlled by gas control panel 260 in several different ways. For example, one or both of the laminar and accelerator flows may be preset at a first constant flow level during operation of a packaging machine, and otherwise be set to a second constant flow level, or turned off, during non-operational stages of the packaging machine. Likewise, one or both of the laminar and accelerator flows may be preset at a first variable flow level during operation of a packaging machine, and otherwise be set to a second variable flow level, or turned off, during non-operational stages of the packaging machine. For the variable flow setup, the flow parameters may be dependent on gas analyzer 306, packaging machine speed, or other parameters, as would be apparent to a skilled artisan. Additionally, for the variable flow setup, a number of different control algorithms, such as PID, Speed, Minimum, Maximum, Linear, Logarithmic, etc., may be used to control and adjust the variable flow rate. Combinations of these modes may also be overlaid to achieve the desired control.

In an alternative configuration, one or both of the laminar and accelerator flows may be preset at a variable flow level during operation of a packaging machine, and otherwise be set to a constant flow level, or turned off, during non-operational stages of the packaging machine. Additionally, the variable flow level during operation of the packaging machine may be changed to a constant flow level if the speed of the packaging operation exceeds a predetermined threshold.

In yet another alternative configuration, one or both of the laminar and accelerator flows may be pulsed at fixed or variable intervals, depending on the operational state of a packaging machine.

Referring to FIGS. 22 and 28, in an exemplary setup for supplying a specified gas environment to a package 63, an operator may input a predetermined gas level into operator interface 262 based upon the specifications of package 63. An operator may likewise specify the delivery parameters for delivering gas through gassing lance 40 (i.e. constant, variable, pulsed etc.). Gas supplied via gas supply 285 and through filter/regulator 284 may be distributed by gas distribution manifold 286. Programmable Logic Control 274 may control the operation of the various electronic components to control laminar flow through flexible tube 146, so that feedback from gas analyzer 306 may ramp the laminar flow up or down to maintain the gas level in the proximity of package 63 at a desired level. If specified, the accelerator flow through flexible tube 152 may be pulsed at a rate proportional to the operational timing of the particular packaging machine, and turned off momentarily before the sealing of package 63 to allow the contents thereof to settle. The above-identified operations may be repeated until an operator was to stop the gas delivery process or specify new parameters.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A gassing lance comprising:
a base including a docking port connectable to an input member for transmitting gas to said gassing lance; and
an extension including:
at least one laminar gassing element for transmitting gas through said gassing lance at a first flow rate; and
at least one accelerator gassing element for transmitting gas through said gassing lance at a second flow rate.

2. A gassing lance according to claim 1, said base being removably connectable with said extension.

3. A gassing lance according to claim 1, said base including:
at least one input laminar port and at least one output laminar port;
at least one input accelerator port and at least one output accelerator port; and
at least one input analyzer port and at least one output analyzer port.

4. A gassing lance according to claim 3, said docking port including:
at least one input laminar port and at least one output laminar port;
at least one input accelerator port and at least one output accelerator port; and
at least one input analyzer port and at least one output analyzer port.

5. A gassing lance according to claim 4, wherein when said docking port is connected to said base, said input laminar port, said input accelerator port and said output analyzer port on said base being respectively interlinked with said output laminar port, said output accelerator port and said input analyzer port on said docking port, so as to enable the passage of gas between each of said respective input and output ports.

6. A gassing lance according to claim 4, said input member including:
at least one input laminar port and at least one output laminar port;
at least one input accelerator port and at least one output accelerator port; and
at least one input analyzer port and at least one output analyzer port.

7. A gassing lance according to claim 6, wherein when said input member is connected to said docking port, said input laminar port, said input accelerator port and said output analyzer port on said docking port being respectively interlinked with said output laminar port, said output accelerator port and said input analyzer port on said input member, so as to enable the passage of gas between each of said respective input and output ports.

8. A gassing lance according to claim 1, said docking port being removably connectable to said base.

9. A gassing lance according to claim 6, said docking port including an externally threaded surface engageable with an internally threaded engagement section on said input member,
wherein when said input member is connected to said docking port, said input laminar port, said input accelerator port and said output analyzer port on said docking port being respectively interlinked with said output laminar port, said output accelerator port and said input analyzer port on said input member, so as to enable the passage of gas between each of said respective input and output ports.

10. A gassing lance according to claim 1, said docking port including at least one guide hole engageable with at least one respective locating pin on said input member.

11. A gassing lance according to claim 3, said extension including first and second ends, said first end being removably connectable with said base, said gassing lance further comprising:
an accelerator tube including first and second ends, said first end of said accelerator tube being connectable with said output accelerator port on said base and said second end of said accelerator tube terminating substantially adjacent said second end of said extension.

12. A gassing lance according to claim 11, said accelerator tube including at least one hole having a central axis substantially orthogonal to a central axis of said accelerator tube.

13. A gassing lance according to claim 11, said accelerator tube being removably connectable with said base by means of a set screw disposed in a threaded hole in said base, an end of said set screw being engageable with said accelerator tube to connect said accelerator tube to said base.

14. A gassing lance according to claim 11, said accelerator tube including an endpiece disposed adjacent said second end thereof, said endpiece including an analyzer hole disposed substantially orthogonal to a gassing lance central axis.

15. A gassing lance according to claim 14, said analyzer hole being interlinked with an output connector disposed on said endpiece, an analyzer tube being connectable with said output connector to permit the transmission of gas from said analyzer hole to said input analyzer port.

16. A gassing lance according to claim 1, said extension including first and second ends, said first end being removably connectable to said base,
said laminar gassing element being disposed substantially adjacent said second end of said extension on a surface of said extension for transmitting gas substantially perpendicular to a gassing lance central axis,
said accelerator gassing element including first and second accelerator gassing elements,
said first accelerator gassing element being disposed substantially adjacent said second end of said extension on a surface of said extension for transmitting gas substantially perpendicular to said gassing lance central axis,
said second accelerator gassing element being disposed substantially adjacent said second end of said extension on an end of said extension for transmitting gas substantially parallel to said gassing lance central axis.

17. A gassing lance according to claim 16, a surface area of said laminar gassing element being greater than a surface area of at least one of:
said first accelerator gassing element, and
said second accelerator gassing element.

18. A gassing lance according to claim 1, said extension including first and second ends, said first end being removably connectable with said base, said gassing lance further comprising:
an accelerator tube including first and second ends, said first end of said accelerator tube being connectable with an output accelerator port on said base and said second end of said accelerator tube terminating substantially adjacent said second end of said extension, and
at least one spacer disposable adjacent said second end of said accelerator tube, said spacer including at least one first opening disposed along a gassing lance central axis and at least one second opening disposed substantially orthogonal to said gassing lance central axis,
wherein said first opening permits transmission of gas substantially parallel to said gassing lance central axis and said second opening permits transmission of gas substantially orthogonal to said gassing lance central axis.

19. A gassing lance according to claim 18, further comprising at least one baffle element disposable adjacent said spacer for controlling transmission of gas through said first and second openings in said spacer.

20. A gassing lance according to claim 19, further comprising an endcap disposable adjacent said second end of said extension.

21. A gassing lance according to claim 1, each of said laminar and accelerator gassing elements including at least one wire mesh including a plurality of microscopic holes enabling transmission of gas therethrough.

22. A gassing lance according to claim 1, wherein a gassing lance cross section perpendicular to a gassing lance central axis includes a first generally curved surface and at least one second generally flat surface, said curved surface being disposable adjacent an inner surface of a forming tube when said gassing lance is mounted to the forming tube.

23. A gassing lance according to claim 22, said gassing lance being mountable in a hole provided in the forming tube,
wherein, when said gassing lance is mounted to the forming tube, said gassing lance docking port protrudes through the hole, and said gassing lance base and extension are disposed inside the forming tube.

24. A gassing lance according to claim 1, said base being disposed at an angle relative to said extension.

25. A gassing lance according to claim 1, said first flow rate being less than said second flow rate.

26. A method of supplying gas through a gassing lance disposable in a forming tube of a packaging machine, said gassing lance comprising:
a base including a docking port connectable to an input member for transmitting gas to said gassing lance; and
an extension including:
at least one laminar gassing element for transmitting gas through said gassing lance; and
at least one accelerator gassing element for transmitting gas through said gassing lance, said method comprising the steps of:
connecting said input member to said docking port;
transmitting gas through said laminar gassing element at a first flow rate; and
transmitting gas through said accelerator gassing element at a second flow rate.

27. A method according to claim 26, said base including:
at least one input laminar port and at least one output laminar port;
at least one input accelerator port and at least one output accelerator port; and
at least one input analyzer port and at least one output analyzer port.

28. A method according to claim 27, said docking port including:
at least one input laminar port and at least one output laminar port;
at least one input accelerator port and at least one output accelerator port; and
at least one input analyzer port and at least one output analyzer port.

29. A method according to claim 28, further comprising the steps of:
connecting said docking port to said base; and
interlinking said input laminar port, said input accelerator port and said output analyzer port on said base with said output laminar port, said output accelerator port and said input analyzer port on said docking port, respectively, so as to enable the passage of gas between each of said respective input and output ports.

30. A method according to claim 28, said input member including:
at least one input laminar port and at least one output laminar port;
at least one input accelerator port and at least one output accelerator port; and
at least one input analyzer port and at least one output analyzer port.

31. A method according to claim 30, further comprising the step of:
interlinking said input laminar port, said input accelerator port and said output analyzer port on said docking port with said output laminar port, said output accelerator port and said input analyzer port on said input member, respectively, so as to enable the passage of gas between each of said respective input and output ports.

32. A method according to claim 30, further comprising the steps of:
engaging an internally threaded engagement section on said input member to an externally threaded surface of said docking port to connect said input member to said docking port; and
interlinking said input laminar port, said input accelerator port and said output analyzer port on said docking port with said output laminar port, said output accelerator port and said input analyzer port on said input member, respectively, so as to enable the passage of gas between each of said respective input and output ports.

33. A method according to claim 26, further comprising the step of:
engaging at least one locating pin provided on said input member with at least one respective hole in said docking port, said hole guiding engagement of said docking port with said locating pin on said input member.

34. A method according to claim 27, said extension including first and second ends, said first end being removably connectable with said base, said gassing lance further comprising an accelerator tube including first and second ends, said second end of said accelerator tube terminating substantially adjacent said second end of said extension, said method further comprising the steps of:
connecting said first end of said extension to said base; and
connecting said first end of said accelerator tube with said output accelerator port on said base.

35. A method according to claim 34, further comprising the step of:
providing at least one hole in said accelerator tube, said hole having a central axis substantially orthogonal to a central axis of said accelerator tube.

36. A method according to claim 34, further comprising the steps of:
connecting said accelerator tube with said base by means of a set screw disposed in a threaded hole in said base; and
engaging an end of said set screw with said accelerator tube to connect said accelerator tube to said base.

37. A method according to claim 34, further comprising the step of:
providing an endpiece disposed adjacent said second end of said accelerator tube, said endpiece including an analyzer hole disposed substantially orthogonal to a gassing lance central axis.

38. A method according to claim 37, further comprising the steps of:
interlinking said analyzer hole with an output connector disposed on said endpiece; and
connecting an analyzer tube with said output connector to permit the transmission of gas from said analyzer hole to said input analyzer port.

39. A method according to claim 26, said extension including first and second ends, said accelerator gassing element including first and second accelerator gassing elements, said method further comprising the steps of:
connecting said first end of said extension to said base;
disposing said laminar gassing element substantially adjacent said second end of said extension on a surface of said extension for transmitting gas substantially perpendicular to a gassing lance central axis;
disposing said first accelerator gassing element substantially adjacent said second end of said extension on a surface of said extension for transmitting gas substantially perpendicular to said gassing lance central axis; and
disposing said second accelerator gassing element substantially adjacent said second end of said extension on an end of said extension for transmitting gas substantially parallel to said gassing lance central axis.

40. A method according to claim 39, a surface area of said laminar gassing element being greater than a surface area of at least one of:
said first accelerator gassing element, and
said second accelerator gassing element.

41. A method according to claim 26, said extension including first and second ends, said gassing lance further comprising an accelerator tube including first and second ends, said second end of said accelerator tube terminating substantially adjacent said second end of said extension, said method further comprising the steps of:
connecting said first end of said extension with said base;
connecting said first end of said accelerator tube with an output accelerator port on said base; and
disposing at least one spacer adjacent said second end of said accelerator tube, said spacer including at least one first opening disposed along a gassing lance central axis and at least one second opening disposed substantially orthogonal to said gassing lance central axis, wherein said first opening permits transmission of gas substantially parallel to said gassing lance central axis and said second opening permits transmission of gas substantially orthogonal to said gassing lance central axis.

42. A method according to claim 41, further comprising the step of:
disposing at least one baffle element adjacent said spacer for controlling transmission of gas through said first and second openings in said spacer.

43. A method according to claim 42, further comprising the step of:
disposing an endcap adjacent said second end of said extension.

44. A method according to claim 26, further comprising the step of:
providing a plurality of microscopic holes in each of said laminar and accelerator gassing elements for enabling transmission of gas therethrough.

45. A method according to claim 26, wherein a gassing lance cross section perpendicular to a gassing lance central axis includes a first generally curved surface and at least one second generally flat surface, said method further comprising the step of:
disposing said curved surface adjacent an inner surface of a forming tube when said gassing lance is mounted to the forming tube.

46. A method according to claim 45, further comprising the step of:
mounting said gassing lance in a hole provided in the forming tube,
wherein said gassing lance docking port protrudes through the hole, and said gassing lance base and extension are disposed inside the forming tube.

47. A method according to claim 26, further comprising the step of:
disposing said base at an angle relative to said extension.

48. A method according to claim 26, said first flow rate being less than said second flow rate.

49. A gas control panel for controlling and directing gas flow, said gas control panel comprising:
at least one first circuit for controlling gas flow at a first flow rate through at least one gassing lance;
an operator interface for setting forth a desired gas characteristic;
a gas analyzer for measuring a gas characteristic for gas flowing through the gassing lance, said gas characteristic constituting a measured gas characteristic and corresponding, one of directly and indirectly, to said desired gas characteristic;
at least one second circuit for controlling gas flow at a second flow rate through the gassing lance; and
a control system for controlling said first and second circuits such that said measured gas characteristic corresponds to said desired gas characteristic.

50. A gas control panel according to claim 49, said control system being a Programmable Logic Control.

51. A gas control panel according to claim 49, further comprising:
a gas supply for supplying gas to said gas control panel;
a filter-regulator for filtering and regulating flow of gas from said gas supply; and
a gas distribution manifold for distributing gas supplied from said filter-regulator to said first and second circuits.

52. A gas control panel according to claim 49, said first circuit further comprising:
an electronic pressure regulator for increasing or decreasing gas flow controlled by said first circuit based upon a gas flow reading by a flow indicator.

53. A gas control panel according to claim 52, said flow indicator being connected in series between said electronic pressure regulator and a solenoid valve.

54. A gas control panel according to claim 49, said second circuit further comprising:
an electronic pressure regulator for increasing or decreasing gas flow controlled by said second circuit based upon a gas flow reading by a flow indicator.

55. A gas control panel according to claim 54, said flow indicator being connected in series between said electronic pressure regulator and a solenoid valve.

56. A gas control panel according to claim 49, said gas characteristic measured by said gas analyzer being converted into a deliverable gas flow via a control scheme.

57. A gas control panel according to claim 56, said control scheme being at least one of:
PID, Speed, Minimum, Maximum, Linear, and Logarithmic.

58. A gas control panel according to claim 49, said second flow rate being greater than said first flow rate.

59. A gas control panel according to claim 49, during operation of a packaging machine, said first flow rate being at least one of:
constant, pulsed, dependent upon an operational speed of the packaging machine, dependent upon an operational state of the packaging machine, and variable,
and said second flow rate being at least one of:
constant, pulsed, dependent upon an operational speed of the packaging machine, dependent upon an operational state of the packaging machine, and variable.

60. A gas control panel according to claim 49, during a non-operational state of a packaging machine, said first flow rate being at least one of:
constant, pulsed, dependent upon an operational speed of the packaging machine, dependent upon an operational state of the packaging machine, and variable,
and said second flow rate being at least one of:
constant, pulsed, dependent upon an operational speed of the packaging machine, dependent upon an operational state of the packaging machine, and variable.

61. A gas control panel according to claim 49, said first flow rate being increased or decreased based upon said gas characteristic measurement.

62. A gas control panel according to claim 49, said second flow rate being increased or decreased based upon said gas characteristic measurement.

63. A gas control panel according to claim 49, said control system being programmed for a plurality of flow rates corresponding to said desired gas characteristics.

64. A gas control panel for controlling and directing gas flow, said gas control panel comprising:
a plurality of circuits for controlling gas flow at a plurality of flow rates;
an operator interface for setting forth desired gas characteristics;
a gas analyzer for measuring gas characteristics of gas directed by said gas control panel, said gas characteristics constituting measured gas characteristics and corresponding, one of directly and indirectly, to said desired gas characteristics; and
a Programmable Logic Control for controlling said circuits such that said measured gas characteristics correspond to said desired gas characteristics.

65. A method of controlling and directing gas flow, said method comprising the steps of:
providing at least one first circuit for controlling gas flow at a first flow rate through at least one gassing lance;
setting forth a desired gas characteristic;
measuring a gas characteristic for gas flowing through the gassing lance, said gas characteristic constituting a measured gas characteristic and corresponding, one of directly and indirectly, to said desired gas characteristic; and
controlling said first circuit such that said measured gas characteristic corresponds to said desired gas characteristic.

66. A method according to claim 65, further comprising the step of:
providing at least one second circuit for controlling gas flow at a second flow rate through the gassing lance,
controlling said second circuit such that said measured gas characteristic corresponds to said desired gas characteristic.

67. A method according to claim 66, further comprising the steps of:
filtering and regulating flow of gas from a gas supply; and
distributing said filtered and regulated gas to said first and second circuits.

68. A method according to claim 65, further comprising the step of:
increasing or decreasing gas flow controlled by said first circuit based upon a gas flow reading.

69. A method according to claim 66, further comprising the step of:
increasing or decreasing gas flow controlled by said second circuit based upon a gas flow reading.

70. A method according to claim 65, further comprising the step of:
converting said measured gas characteristic into a deliverable gas flow via a control scheme.

71. A method according to claim 70, said control scheme being at least one of:
PID, Speed, Minimum, Maximum, Linear, and Logarithmic.

72. A method according to claim 66, said second flow rate being greater than said first flow rate.

73. A method according to claim 66, during operation of a packaging machine, said first flow rate being at least one of:
constant, pulsed, dependent upon an operational speed of the packaging machine, dependent upon an operational state of the packaging machine, and variable,
and said second flow rate being at least one of:
constant, pulsed, dependent upon an operational speed of the packaging machine, dependent upon an operational state of the packaging machine, and variable.

74. A method according to claim 66, during a non-operational state of a packaging machine, said first flow rate being at least one of:
constant, pulsed, dependent upon an operational speed of the packaging machine, dependent upon an operational state of the packaging machine, and variable,
and said second flow rate being at least one of:
constant, pulsed, dependent upon an operational speed of the packaging machine, dependent upon an operational state of the packaging machine, and variable.

75. A method according to claim 65, said first flow rate being increased or decreased based upon said gas characteristic measurement.

76. A method according to claim 66, said second flow rate being increased or decreased based upon said gas characteristic measurement.
